(19) United States
(12) Patent Application Publication
(10) Pub. No.: US 2023/0026092 A1
(43) Pub. Date: Jan. 26, 2023

(54) EQUIPMENT RECORDING SYSTEM AND EQUIPMENT RECORDING METHOD

(71) Applicant: Shimadzu Corporation, Kyoto-shi (JP)

(72) Inventors: Mitsuo YAMASHITA, Kyoto-shi (JP); Makoto SHINOHARA, Kyoto-shi (JP)

(21) Appl. No.: 17/380,803

(22) Filed: Jul. 20, 2021

(51) Int. Cl. H04N 7/18; H04R 1/08; H04N 5/77

(52) U.S. Cl. CPC H04N 7/183; H04R 1/08; H04N 5/77

(57) ABSTRACT

An equipment recording system is provided with at least one of a microphone and a camera, and a server. The server is configured to store at least one of information on a sound of a measurement target and information on a moving image of the measurement target, which have been stored before and after the time point at which an abnormality-related signal of the equipment has occurred in a state of being associated with the abnormality-related signal of the equipment.

### CROSS-REFERENCE TO RELATED APPLICATIONS

The related application number JP2019-003797, entitled “EQUIPMENT RECORDING SYSTEM AND EQUIPMENT RECORDING METHOD”, filed on Jan. 11, 2019, invented by Mitsuo YAMASHITA, Makoto SHINOHARA, upon which this patent application is based, is hereby incorporated by reference in its entirety.

### BACKGROUND OF THE INVENTION

### Field of the Invention

The present invention relates to an equipment recording system and an equipment recording method, and more particularly to an equipment recording system and an equipment recording method for recording information on equipment at the time when an abnormality has occurred.

### Description of the Background Art

Conventionally, there has been known an equipment recording system for recording information on an equipment image at the time when an abnormality has occurred. Such a system is disclosed, for example, in Japanese Unexamined Patent Application Publication No. S63-46517.

The above-described Japanese Unexamined Patent Application Publication No. S63-46517 discloses a surveillance control computer system (equipment recording system) for monitoring equipment, such as, e.g., a plant. This surveillance control computer system is configured to monitor equipment by an industrial TV camera. This surveillance control computer system is configured to record (store) information on a monitor image of equipment by an industrial TV camera before and after an event (abnormality) has occurred in the equipment in a recorder provided at the equipment. With this, it is possible to analyze the information on the surveillance video of the equipment recorded (stored) in the recorder after the occurrence of the event (abnormality).

However, in the surveillance control computer system described in the above-described Japanese Unexamined Patent Application Publication No. S63-46517, the information on the surveillance video of the equipment is stored in the recorder arranged in the equipment. Therefore, in a case where the operator of the equipment differs from the operator of the surveillance control computer system, it is difficult for the operator belonging to the operator of the surveillance control computer system to freely perform administrative operations, such as, e.g., a maintenance and inspection of the recorder arranged in the equipment. In this instance, it is difficult to easily manage the information (measurement information on the measurement target) on the stored equipment surveillance video.

Further, in the surveillance control computer system described in the above-described Japanese Unexamined Patent Application Publication No. S63-46517, the information on the equipment surveillance video is simply stored in the recorder. For this reason, it is difficult to confirm ex post facto what equipment event caused the information on the stored equipment surveillance video. Therefore, it is difficult to easily analyze the information (measurement information on the measurement target) of the stored surveillance video on the equipment.

### SUMMARY OF THE INVENTION

In order to attain the above-described objects, an equipment recording system according to a first aspect of the present invention, includes:

at least one of a microphone and a camera; and

a server,

wherein the microphone is configured to record information on a sound of a measurement target of equipment,

wherein the camera is configured to record information on a moving image of the measurement target, and

wherein the server is configured to:

receive at least one of the information on the sound of the measurement target and the information on the moving image of the measurement target via a network, the information on the sound and the information on the moving image having being recorded before and after a time point at which an abnormality-related signal of the equipment occurred; and

store at least one of received information on the sound of the measurement target and received information on the moving image of the measurement target in a state of being associated with the abnormality-related signal of the equipment.

Note that in this specification, “equipment” is a broad concept including not only mere equipment but also, for example, a facility, such as, e.g., a manufacturing plant, and a structure, such as, e.g., a bridge and a tunnel.

The equipment recording system according to the first aspect of the present invention is provided with, as described above, a server configured to receive and store at least one of the information on the sound of the measurement target and the information on the moving image of the measurement target via the network. It is thus possible to manage the measurement information on the measurement target, which is at least one of the information on the sound of the measurement target and the information on the moving image of the measurement target, in a server located at a remote location away from the equipment. Consequently, in a case where the equipment operator is different from the equipment recording system operator, the operator belonging to the equipment recording system can freely control the server. Therefore, it is possible to easily manage the measurement information on the stored measurement target.

Further, in the equipment recording system according to the first aspect of the present invention, as described above, at least one of the information on the sound of the measurement target and the information on the moving image of the measurement target is stored in a state of being associated with the abnormality-related signal of the equipment. Therefore, the correspondence between the measurement information on the measurement target, which is at least one of the information on the stored sound of the measurement target and the information on the stored moving image of the measurement target, and the abnormality of the equipment can be reliably confirmed in a posteriori manner. Consequently, it is possible to prevent the correspondence between the stored measurement information on the measurement target and the abnormality of the equipment from becoming unknown when analyzing the measurement information on the measurement target. This makes it possible to easily analyze the stored measurement information on the measurement target. As a result, it is possible to provide an equipment recording system that can easily manage the stored measurement information on the measurement target and can easily analyze the stored measurement information on the measurement target.

In addition, in the equipment recording system according to the first aspect of the present invention, in the case of storing the measurement information on the measurement target by placing a server at a remote location away from the equipment, it is not easy to confirm the correspondence between the measurement information on the measurement target and the abnormality-related signal of the equipment ex post facto. Therefore, as described above, it is useful that it is possible to easily analyze the measurement information on the measurement target by suppressing that the correlation with the equipment abnormality becomes unknown. It is particularly useful in a case where the measurement information on the measurement target is stored in a server arranged at a remote location away from the equipment.

In the equipment recording system according to the first aspect of the present invention, preferably, the microphone and the camera each are a microphone-equipped camera capable of recording both the information on the sound of the measurement target and the information on the moving image of the measurement target.

With this configuration, both the information on the sound of the measurement target and the information on the moving image of the measurement target can be recorded simultaneously by the microphone-equipped camera. Therefore, when an abnormality-related signal of the equipment has occurred, both the information on the sound of the measurement target and the information on moving image of the measurement target, which have been recorded before and after when the abnormality-related signal of the equipment occurred, can be stored in the server in a state of being associated with the abnormality-related signal of the equipment. Consequently, at the time of analyzing the measurement information on the measurement target, it is possible to confirm both the information on the sound of the measurement target and the information on the moving image of the measurement target, which have been recorded before and after the occurrence of the abnormality-related signal of the equipment, together with the correspondence with the equipment abnormality. This makes it possible to easily analyze the information.

In this case, preferably, the equipment includes a plurality of measurement targets different from each other, and the microphone-equipped camera is provided at each of the plurality of measurement targets.

With this configuration, it is possible to record the information on the sound and the information on the moving image of each of the plurality of measurement targets different from each other. Therefore, it is possible to acquire the information on the sound and the information on the moving image of many measurement targets, as compared with the case in which the information on the sound and the information on the moving image of a single measurement target are recorded. This makes it possible to more easily analyze the information.

In the configuration in which the above-described microphone-equipped camera is provided at each of the plurality of measurement targets, preferably, it is configured such that, when the abnormality-related signal of the equipment has occurred, the information on the sound of the measurement target and the information on the moving image of the measurement target by all of the microphone-equipped cameras are stored in the server in a state of being associated with the abnormality-related signal of the equipment.

With this configuration, unlike the case in which the information on the sound and the information on the moving image of only some of measurement targets are stored in the server, it is possible to confirm the information on the sound and the information on the moving image of all of the measurement targets when analyzing the measurement information on the measurement target. Consequently, even in the measurement target which is seemed to be unrelated to the abnormality-related signal of the equipment, the information on the sound and the information on the moving image will be stored, which in turn can increase the information when analyzing the measurement information on the measurement target. Therefore, it is possible to easily obtain a significant analysis result.

In the configuration in which the above-described microphone-equipped camera is provided at each of the plurality of measurement targets, preferably, it is configured such that the information on the sound of each of the plurality of measurement targets and the information on the moving image of each of the plurality of measurement targets are stored in the server so as to be grouped for each of occurred abnormality-related signals of the equipment.

With this configuration, at the time of analyzing the measurement information on the measurement target, in a group for each generated abnormality-related signal of the equipment, it is possible to utilize the information on the sound of each of the plurality of measurement targets and the information on the moving image of each of the plurality of measurement targets. Therefore, it is possible to more easily analyze the measurement information on the measurement target. This effect is particularly useful when the abnormality-related signal of the equipment has occurred more than once, in that the information can be easily and individually used for each group for the signal related to the occurred abnormality of the equipment.

In the configuration in which the above-described microphone-equipped camera is provided at each measurement target, preferably, it is configured such that the information on the sound of each of the plurality of measurement targets and the information on the moving image of each of the plurality of measurement targets are stored in the server so as to be grouped in a unit of a predetermined time range.

With this configuration, when a significant time range is predetermined as a unit of the time range, it is possible to use the information on the sound of each of the plurality of measurement targets and the information on the moving image of each of the plurality of measurement targets in a group in the unit of the significant time range at the time of analyzing the measurement information on the measurement target. Therefore, it is possible to more easily analyze the measurement information on the measurement target. The significant time range differs depending on equipment, but may be, for example, within or outside the business hours of the equipment, during the day, during the night, etc.

In the equipment recording system according to the first aspect of the present invention, preferably, the server is configured to be capable of delivering at least one of the information on the sound of the measurement target and the information on the moving image of the measurement target to the user terminal via the network.

With this configuration, in a case in which it is necessary to confirm at least one of the information on the sound of the measurement target and the information on the moving image of the measurement target, the user can confirm by the terminal of the user at least one of the information on the sound of the measurement target and the information on the moving image of the measurement target which are required to be confirmed.

The equipment recording method according to the second aspect of the present invention includes the steps of:

recording at least one of information on a sound of a measurement target of equipment and information on a moving image of the measurement target;

receive via a network at least one of the information on the sound of the measurement target and the information on the moving image of the measurement target recorded before and after a time point at which an abnormality-related signal of equipment occurred; and

storing at least one of the received information on the sound of the measurement target and the received information on the moving image of the measurement target in a state of being associated with the abnormality-related signal of the equipment.

In the equipment recording method according to the second aspect of the present invention, by configuring as described above, in the same manner as the above-described equipment recording system according to the first aspect of the present invention, it is possible to provide an equipment recording method capable of easily managing the stored measurement information on the measurement target and easily analyzing the stored measurement information on the measurement target.

### BRIEF DESCRIPTION OF THE DRAWINGS

FIG. 1 is a diagram showing an entire configuration of an equipment recording system according to an embodiment of the present invention.

FIG. 2 is a block diagram showing a configuration of a microphone-equipped camera according to one embodiment of the present invention.

FIG. 3 is a block diagram showing a configuration of a server according to one embodiment of the present invention.

FIG. 4A is a diagram for explaining the recording of measurement information on a measurement target of equipment by a microphone-equipped camera.

FIG. 4B is a diagram for explaining processing in the microphone-equipped camera when an abnormality-related signal has occurred.

FIG. 4C is a diagram for explaining processing for associating the measurement information on the measurement target of the equipment with the abnormality-related signal.

FIG. 5A is a diagram showing an example of the generation of an abnormality-related signal.

FIG. 5B is a diagram showing the group of abnormality-related signals at the time point T1 in the case of FIG. 5A.

FIG. 5C is a diagram showing the group of abnormality-related signals at the time point T2 in the case of FIG. 5A.

FIG. 6A is a diagram showing an example of the generation of an abnormality-related signal.

FIG. 6B is a diagram showing groups in a unit of a predetermined time range in the case of FIG. 6A.

FIG. 7 is a diagram for explaining the distribution of measurement information on a measurement target from a server to equipment of a user terminal according to one embodiment of the present invention.

FIG. 8 is a diagram showing an example of elevator equipment of one example of equipment according to one embodiment of the present invention.

### DESCRIPTION OF THE PREFERRED EMBODIMENT

Hereinafter, some embodiments embodying the present invention will be described with reference to the attached drawings.

### (Configuration of Equipment Recording System)

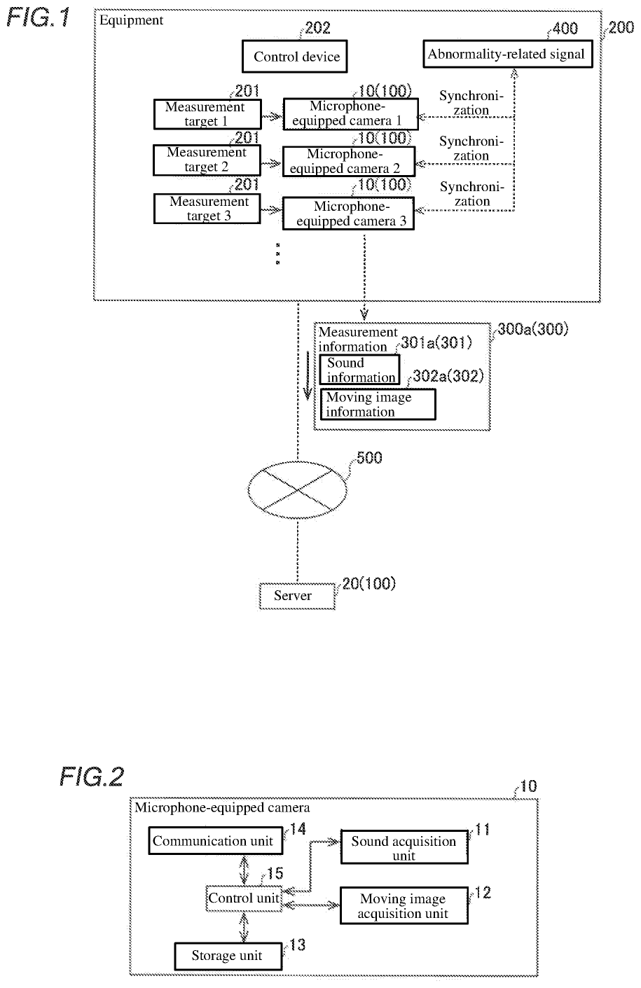

Referring to FIGS. 1 to 7, the configuration of the equipment recording system 100 according to one embodiment of the present invention will be described.

As shown in FIG. 1, the equipment recording system 100 is a system for recording and storing the state of the equipment 200 before and after the occurrence of an event relating to an abnormality. The equipment 200, which is a recording target, may be, for example, equipment, such as, e.g., an elevator, a facility, such as, e.g., a manufacturing plant, a structure, such as, e.g., a bridge and a tunnel, or the like. An example in which the equipment 200 is an elevator will be described later.

The equipment 200 may include a plurality of measurement targets 201 different from each other. Although the number of the measurement targets 201 included in the equipment 200 may not be limited, and FIG. 1 illustrates an example in which the equipment 200 includes three or more measurement targets 201. The plurality of measurement targets 201 may be, for example, distinct portions of the equipment 200. Further, for example, the plurality of measurement targets 201 may be distinct functional portions of the equipment 200. As the measurement target 201, a portion that is likely to be related to an abnormality of the equipment 200 is determined in advance and selected.

The equipment recording system 100 is configured to individually record the state of each of the plurality of measurement targets 201 of the equipment 200. Specifically, the equipment recording system 100 is provided with a microphone-equipped camera 10 for recording the information 301 on the sound of the measurement target 201 of the equipment 200 and the information 302 on the moving image of the measurement target 201 of the equipment 200. The microphone-equipped camera 10 is provided for each of the plurality of measurement target 201 of the equipment 200. Each of the plurality of microphone-equipped cameras 10 is provided to monitor each of the plurality of measurement targets 201 of the equipment 200. Each of the plurality of microphone-equipped cameras 10 is provided to record the information 302 on the moving image including the information 301 on the sound of each of the plurality of measurement targets 201 of the equipment 200. Note that the microphone-equipped camera 10 is an example of the “microphone” and the “camera” recited in claims.

Further, the microphone-equipped camera 10 is configured to operate synchronously with the signal 400 related to the occurred abnormality of the equipment 200 when the abnormality-related signal 400 of the equipment 200 has occurred in the equipment 200. That is, the microphone-equipped camera 10 is configured to output the information 301 on the sound of the measurement target 201 of the equipment 200 and the information 302 on the moving image to an outside storage, when an abnormality-related signal 400 related to the equipment 200 has occurred in the equipment 200. The information 301 on the sound and the information 302 on the moving image are information recorded before and after the time when the abnormality-related signal 400 of the equipment has occurred. The abnormality-related signal 400 of the equipment 200 is a trigger signal for operating the microphone-equipped camera 10. Hereinafter, the information 301 on the sound of the measurement target 201 of the equipment 200 and the information 302 on the moving image of the equipment 200, which have been recorded before and after the time when the abnormality-related signal 400 of the equipment 200 occurred, will be referred to as the information 301a on the sound and the information 302a on the moving image of the measurement target 201 of the equipment 200, respectively. In the following, for ease of explanation, the information including both the information 301 (301a) on the sound of the measurement target 201 of the equipment 200 and the information 302 (302a) on the moving image is sometimes referred to as measurement information 300 (300a) of the measurement target 201 of the equipment 200.

The abnormality-related signal 400 of the equipment 200 may be, for example, a signal generated in the equipment 200 when an abnormality of the equipment 200 is recognized based on a detection result of the detection target by the sensor for detecting the abnormality of the equipment 200 provided in the equipment 200. The sensor for detecting an abnormality in the equipment 200 differs depending on the equipment 200. This sensor may be, for example, a position sensor, a speed sensor, an acceleration sensor, a distortion sensor, a vibration sensor, a current sensor, a voltage sensor, a power sensor, a temperature sensor, a humidity sensor, a weight sensor, and a magnetic sensor. The abnormality-related signal 400 of the equipment 200 may be, for example, a signal generated in the equipment 200 when an operation unit for performing an operation related to an abnormality of the equipment 200 provided in the equipment 200 is operated. The operation unit for performing an operation relating to an abnormality of the equipment 200 may be, for example, an operation unit for stopping the operation of the equipment 200, an operation unit for restarting the operation of the equipment 200, and the like. The abnormality-related signal 400 of the equipment 200 may include plural types of signals.

Here, in this embodiment, the equipment recording system 100 is configured to store and manage the information 301a on a sound and the information 302a on a moving image of the measurement target 201 of the equipment 200, which are output from the microphone-equipped cameras 10, at a remote location away from the equipment 200. Specifically, the equipment recording system 100 is provided with the server 20 for receiving the information 301a on a sound and the information 301b on a moving image of the measurement target 201 of the equipment 200, which are output from the microphone-equipped cameras 10, via the network 500, such as, e.g., the Internet. The server 20 is configured to store the information 301a on a sound and the information 302a on a moving image of the measurement target 201 of the equipment 200, which are received via the network 500, in a state of being associated with the abnormality-related signal 400 of the equipment 200.

### (Configuration of Microphone-Equipped Camera)

Next, referring to FIG. 2, the configuration of the microphone-equipped camera 10 of the equipment recording system 100 will be described. As shown in FIG. 2, the microphone-equipped camera 10 is provided with a sound acquisition unit 11, a moving image acquisition unit 12, a storage unit 13, a communication unit 14, and a control unit 15. The sound acquisition unit 11 is portion that serves as a mike (microphone) for the microphone-equipped camera 10. The sound acquisition unit 11 acquires a sound generated in the measurement target 201 and outputs information (sound data) 301 on the measurement target 201, which is an electric signal corresponding to the acquired sound. The moving image acquisition unit 12 is a portion that functions as a camera of the microphone-equipped camera 10. The moving image acquisition unit 12 images the measurement target 201 as a subject and outputs information 302 (moving image data) on the moving image of the measurement target 201, which is an electric signal corresponding to the imaged measurement target 201.

The storage unit 13 is a storage medium including, for example, a flash memory. The storage unit 13 records (stores) the information 301 on the sound of the measurement target 201 acquired by the sound acquisition unit 11 and the information 302 on the moving image of the measurement target 201 acquired by the moving image acquisition unit 12. The communication unit 14 is an interface for communication. The communication unit 14 communicably connects the microphone-equipped camera 10 to the communication target. The communication target of the microphone-equipped camera 10 may be, for example, the server 20, the control device 202 (see FIG. 1), etc., for the equipment 200 provided in the equipment 200. The communication of the microphone-equipped camera 10 may be wired communication or wireless communication, but it is preferable to be wireless communication from the viewpoint of ease of installation of the microphone-equipped camera 10. The control unit 15 includes a processor, such as, e.g., a CPU, and a memory for storing information. The control unit 15 is constituted by a control circuit for controlling the operation of the microphone-equipped camera 10. From the viewpoint of improving the ease of installation, supplying power to the microphone-equipped camera 10 is preferably a battery or a non-contact power supply. Preferably, the microphone-equipped camera 10 is made to be wireless by a wireless technique. Further, from the viewpoint of improving the ease of installation, the microphone-equipped camera 10 is preferably provided with a mounting portion, such as, e.g., a magnet, a clamp, and a clip, which is easy to install to an installation position.

### (Configuration of Server)

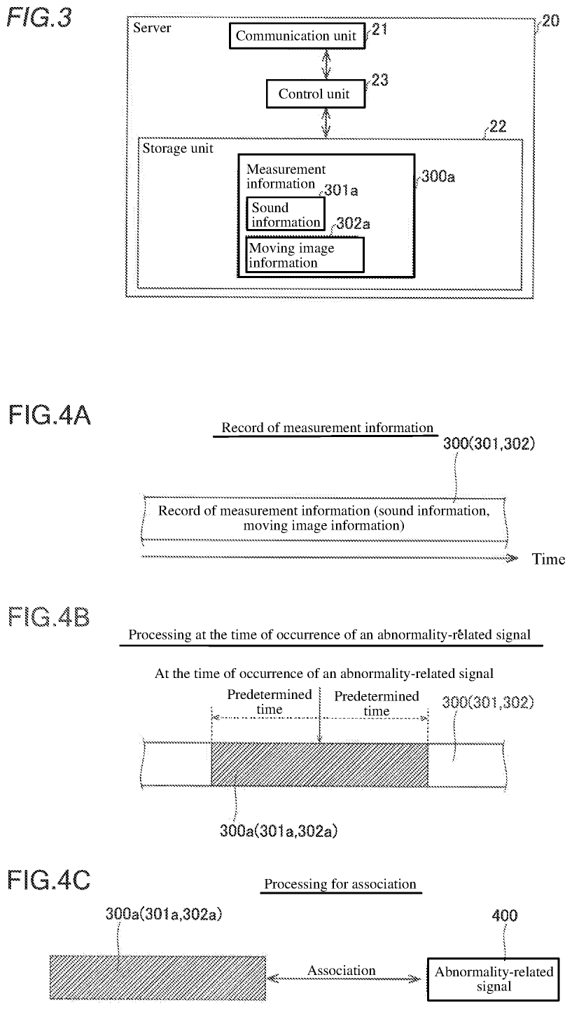

Next, referring to FIG. 3, the configuration of the server 20 of the equipment recording system 100 will be described. As shown in FIG. 3, the server 20 is provided with a communication unit 21, a storage unit 22, and a control unit 23. The communication unit 21 is an interface for communication. The communication unit 21 communicably connects the server 20 and the network 500. That is, the communication unit 21 connects the server 20 and the communication target connected to the network 500 in a communicable manner via the network 500. The communication target of the server 20 may be, for example, the microphone-equipped camera 10, the control device 202 (see FIG. 1), or the like. The storage unit 22 is a mass storage medium, such as, e.g., a hard disk drive. The storage unit 22 stores (records) the information 301a on the sound of the measurement target 201 and the information 302a on the moving image of the measurement target 201, which are output from the microphone-equipped camera 10. In FIG. 3, only one piece of the information 301a on a sound and one piece of the information 302a on a moving image are shown for easier comprehension. In practice, however, a larger number of pieces of the information 301a on a sound and a larger number of pieces of the information 302a on the moving image may be stored in the storage unit 22. The control unit 23 includes a processor, such as, e.g., a CPU, and a memory for storing information. The control unit 23 is configured by a control circuit for controlling the operation of the server 20.

(Processing when Abnormality-Related Signal has Occurred)

Next, referring to FIGS. 4A to C, the processing of the equipment recording system 100 when an abnormality-related signal 400 of the equipment 200 has occurred in the equipment 200 will be described.

As shown in FIG. 4A, the control unit 15 of the microphone-equipped camera 10 performs the control for continuously recording the measurement information 300 (information 302 on a sound and the information 301 on a moving image) on the equipment 200 of the measurement target 201 in the storage unit 13. Further, the control unit 15 of the microphone-equipped camera 10 performs the following control when the capacity of the measurement information 300 of the measurement target 201 of the equipment 200 which has been recorded in the storage unit 13 has reached a predetermined capacity (upper limit). That is, the control unit 15 performs the control for sequentially erasing the old information among the measurement information 300 on the measurement target 201 of the equipment 200 which has been recorded in the storage unit 13. With this, in the storage unit 13 of the microphone-equipped camera 10, the most recent measurement information 300 on the measurement target 201 of the equipment 200 is continuously recorded.

As shown in FIG. 4B, when an abnormality-related signal 400 of the equipment 200 has occurred in the equipment 200, the control unit 15 of the microphone-equipped camera 10 performs the following control. That is, the control unit 15 performs the control for outputting the measurement information 300 (i.e., measurement information 300a) on the measurement target 201 of the equipment 200 recorded before and after the time when the abnormality-related signal 400 of the equipment 200 has occurred. The measurement information 300a to be output may be, for example, information from a time before the time at which the abnormality-related signal 400 of the equipment 200 has occurred by a predetermined time period to a time after the time at which the abnormality-related signal 400 of the equipment 200 has occurred by a predetermined time period. The predetermined time period may be arbitrarily determined and may be, for example, on the order of minutes. The predetermined time period may be the same value before and after the time at which the abnormality-related signal 400 of the equipment 200 has occurred, or may be different values. In a case where the predetermined time period is about several minutes, the measurement information 300a which is the information recording the states (sounds and moving images) of the measurement target 201 for about several minutes to about ten minutes before and after the time point when the abnormality-related signal 400 of the equipment 200 has occurred.

The destination of the measurement information 300a may be, for example, the control device 202 provided in the equipment 200. In this instance, the control device 202 performs the control for transmitting the acquired measurement information 300a to the server 20 via the network 500. For example, the destination of the measurement information 300a may be the server 20. That is, the control unit 15 of the microphone-equipped camera 10 may perform the control for transmitting the acquired measurement information 300a to the server 20 via the network 500 without using the control device 202.

As shown in FIG. 4C, the measurement information 300a (information 301a on a sound and information 302a on a moving image) is stored in the storage unit 22 of the server 20 in a state of being associated with the abnormality-related signal 400 of the equipment 200. The processing for associating the measurement information 300a with the abnormality-related signal 400 of the equipment 200 may be performed by the equipment 200, for example. That is, the control device 202 or the control unit 15 of the microphone-equipped camera 10 may perform the processing for associating the measurement information 300a with the abnormality-related signal 400 of the equipment 200. In this case, the server 20 receives the measurement information 300a in a state of being associated with the abnormality-related signal 400 of the equipment 200 and stores it in the storage unit 22. The processing for associating the measurement information 300a with the abnormality-related signal 400 of the equipment 200 can be performed by the server 20.

Also, the information to be associated with the abnormality-related signal 400 of the equipment 200 may be not only the information 301a on the sound and the information 302a on the moving image of the measurement target 201 of the equipment 200. In other words, in addition to the information 301a on the sound and the information 302a on the moving image of the measurement target 201 of the equipment 200, additional information other than the information 301a on the sound and the information 302a on the moving image of the measurement target 201 of the equipment 200 may be associated with the abnormality-related signal 400 of the equipment 200. Such additional information may be, for example, the information on the detection target acquired by a sensor for detecting the abnormality before or after the time at which the abnormality-related signal 400 of the equipment 200 has occurred. In this instance, the additional information may be position information, velocity information, acceleration information, strain information, oscillation information, current information, voltage information, power information, temperature information, humidity information, weight information, magnetic information, and the like.

In this embodiment, when an abnormality-related signal 400 of the equipment 200 has occurred, the measurement information 300a (information 301a on a sound and information 302a on a moving image) on the measurement target 201 of the equipment 200 is output from all of the microphone-equipped cameras 10. Specifically, even in a case where an abnormality-related signal 400 of any type of the equipment 200 has occurred, from all of the microphone-equipped cameras 10, the measurement information 300a on the measurement target 201 is output. The measurement information 300a on the measurement target 201 of the equipment 200 by all of the microphone-equipped cameras 10 is stored in the server 20 in a state of being associated with the abnormality-related signal 400 of the equipment 200.

### (Processing for Grouping Measurement Information on Measurement Target of Equipment)

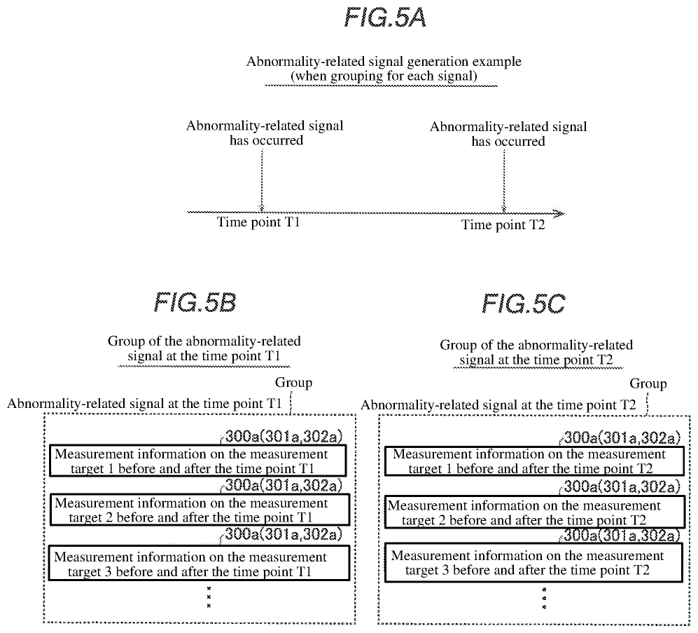

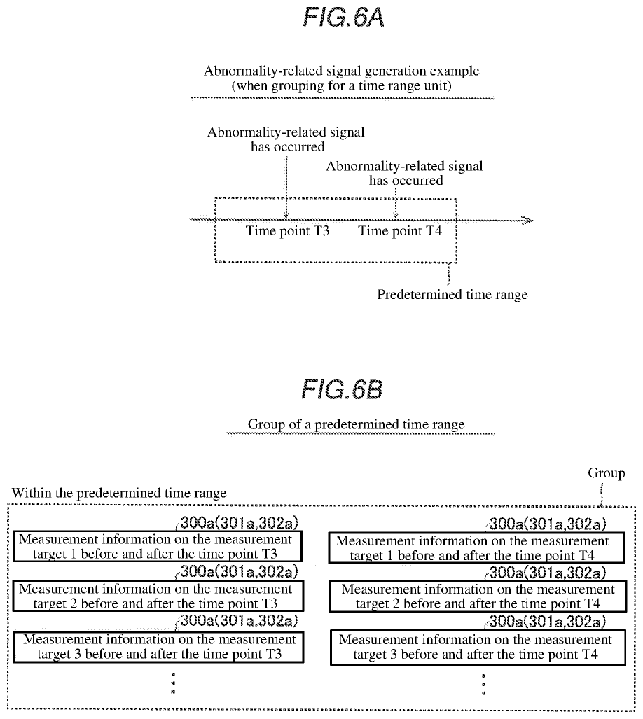

In this embodiment, as shown in FIGS. 5A to 5C and 6A and 6B, the equipment recording system 100 is configured to store the acquired plural pieces of the measurement information 300a on the measurement target 201 of the equipment 200 in the server 20 so as to be grouped. It should be noted that storing plural pieces of the measurement information 300a so as to be grouped means that the measurement information 300a to be grouped is stored in the server 20 in a state of including a tag which is maker information for identifying the group.

For example, the equipment recording system 100 is configured as follows. That is, as shown in FIGS. 5A to 5C, the measurement information 300a (information 301a on a sound and information 302a on a moving image) of each of the plurality of measurement targets 201 is stored in the server 20 so as to be grouped (so as to be available as a group) for each generated abnormality-related signal 400 of the equipment 200. The equipment recording system 100 is configured to be able to manage the measurement information 300a on each of the plurality of measurement targets 201 in a group unit for each generated abnormality-related signal 400 of the equipment 200.

In the example shown in FIGS. 5A to 5C, as shown in FIG. 5A, abnormality-related signals 400 of the equipment 200 have occurred at the time point T1 and at the time point T2 that is later than the time point T1. In this instance, due to the abnormality-related signal 400 occurred at the time point T1, the measurement information 300a on the first measurement target 201, the measurement information 300a on the second measurement target 201, the measurement information 300a on the third measurement target 201 . . . (i.e., the measurement information 300a on all of the equipment 300a) are output from the plurality of microphone-equipped cameras 10. Similarly, due to the abnormality-related signal 400 on the equipment 200 occurred at the time point T2, the measurement information 300a on the first measurement target 201, the measurement information 300a on the second measurement target 201, the measurement information 300a on the third measurement target 201 . . . (i.e., the measurement information 300a on all of the measurement targets 201) are output from the plurality of microphone-equipped cameras 10.

In the server 20, as shown in FIG. 5B, all of the plurality of measurement information 300a caused by the abnormality-related signal 400 of the equipment 200 that occurred at the time point T1 are stored so as to be grouped into one group. Similarly, in the server 20, as shown in FIG. 5C, all of the plurality of measurement information 300a caused by the abnormality-related signal 400 of the equipment 200 occurred at the time point T2 are stored so as to be one group. Although the detailed descriptions will be omitted, the same is applied to the processing of the measurement information 300a caused by the abnormality-related signal 400 of the equipment 200 occurred at another time point.

Further, in another aspect shown in FIGS. 6A and 6B, the equipment recording system 100 is configured to be stored in the server 20 such that the measurement information 300a (information 301a on a sound and information 302a on a moving image) of each of the plurality of measurement targets 201 is grouped (available as a group) in a unit of a predetermined time range. The equipment recording system 100 is configured to be able to manage the measurement information 300a on each of the plurality of measurement targets 201 in a group unit according to a predetermined time range. Note that the predetermined time range differs depending on the equipment 200. The predetermined time range may be, for example, a time range which is the business hours of the equipment 200, a time range which is outside the business hours of the equipment 200, a time range that indicates the daytime, a time range that indicates the nighttime, etc. The predetermined time range may include a plurality of time ranges.

In the example shown in FIGS. 6A and 6B, as shown in FIG. 6A, the abnormality-related signals 400 of the equipment 200 have occurred at the time point T3 and the time point T4 which is the time after the time point T3. In this instance, due to the abnormality-related signal 400 occurred at the time point T3, the measurement information 300a on the first measurement target 201, the measurement information 300a on the second measurement target 201, the measurement information 300a on the third measurement target 201 . . . (i.e., the measurement information 300a on all of the measurement targets 201) are output from the plurality of microphone-equipped cameras 10. Similarly, due to the abnormality-related signal 400 of the equipment 200 occurred at the time point T4, the measurement information 300a on the first measurement target 201, the measurement information 300a on the second measurement target 201, the measurement information 300a on the third measurement target 201 . . . (i.e., the measurement information 300a on all of the measurement targets 201) are output from the plurality of microphone-equipped cameras 10.

In the example shown in FIGS. 6A and 6B, the time point T3 and the time point T4 are within a predetermined time range. In this case, in the server 20, as shown in FIG. 6B, all of the plurality of measurement information 300a caused by the abnormality-related signal 400 of the equipment 200 occurred at the time point T3 and all of the plurality of measurement information 300a caused by the abnormality-related signal 400 of the equipment 200 occurred at the time point T4 are stored in one group as shown in FIG. 6B. Note that it should be noted that the plurality of measurement information 300a caused by the abnormality-related signal 400 of the equipment 200 occurred outside the predetermined period, are not grouped.

### (Processing for Delivering Measurement Information to User Terminal)

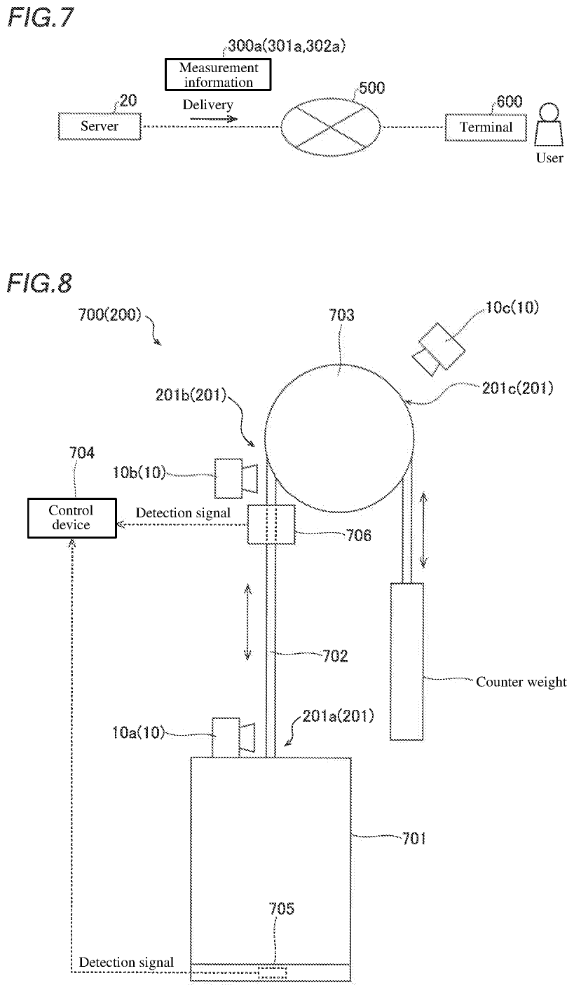

Next, referring to FIG. 7, the distribution of the measurement information 300a from the server 20 to the user terminal 600 will be described. The user may be, for example, the operator of the equipment 200. As shown in FIG. 7, the server 20 is configured to be able to deliver the measurement information 300a (information 301a on a sound and information 302a on a moving image) of the measurement target 201 of the equipment 200 stored in the storage unit 22 to the user terminal 600 via the network 500. The control unit 23 of the server 20 performs the control for delivering the designated measurement information 300a, among plural pieces of the measurement information 300a of the measurement target 201 of the equipment 200 stored in the storage unit 22, to the user terminal 600 via the network 500.

For example, when the control unit 23 of the server 20 receives a delivery instruction from the user terminal 600, the control unit 23 performs the following control. That is, the control unit 23 performs the control for delivering the measurement information 300a specified by the user terminal 600, among the plural pieces of the measurement information 300a on the measurement target 201 of the equipment 200 stored in the storage unit 22, to the user terminal 600 via the network 500. For example, the control unit 23 of the server 20 performs the following control when a notification of the analysis result of the measurement information 300a by an analysis device (not shown) is required. That is, the control unit 23 performs the control for delivering the measurement information 300a that requires notification, among the plural pieces of measurement information 300a on the measurement target 201 of the equipment 200 stored in the storage unit 22, to the user terminal 600 via the network 500.

(Equipment Recording System when Equipment is Elevator Equipment)

Next, referring to FIG. 8, the configuration and the operation of the equipment recording system 100 when the equipment 200 is elevator equipment 700 will be described.

### <Configuration of Elevator Equipment>

As shown in FIG. 8, the elevator equipment 700 is provided with an elevator car 701 for transporting people and luggage, a wire rope 702 for moving the elevator car 701, and a hoisting machine 703 for driving the wire rope 702. The elevator equipment 700 is configured to move the elevator car 701 vertically by moving the wire rope 702 by the hoisting machine 703. The elevator equipment 700 is provided with a control device 704 for controlling the operation of each part of the elevator equipment 700. The control device 704 is an example of the “control device 202” described above.

The elevator car 701 of the elevator equipment 700 is provided with a weight sensor 705 for detecting the weight of a load of the elevator car 701 which is a person or luggage loaded on the elevator car 701. The weight sensor 705 outputs the detection result of the weight of the load of the elevator car 701 to the control device 704. Further, to the wire rope 702 of the elevator equipment 700, a magnetic sensor 706 for magnetically detecting the state of the wire rope 702 is provided. The magnetic sensor 706 outputs a detection result of the state of the wire rope 702 to the control device 704. Note that the weight sensor 705 and the magnetic sensor 706 are examples of the “abnormality-detection sensor of the equipment 200” described above.

Further, the elevator equipment 700 includes three measurement targets 201. The three measurement targets 201 include: the elevator car 701 and its nearby measurement target 201a; the wire rope 702 and its nearby measurement target 201b; and the hoisting machines 703 and its nearby measurement target 201c. The measurement target 201 a is provided with a microphone-equipped camera 10a for recording the information 301 on a sound and the information 302 on a moving image of the elevator car 701 and therearound. Further, the measurement target 201b is provided with a microphone-equipped camera 10b for recording the information 302 on a sound and the information 301 on a moving image of the wire rope 702 and therearound. The measurement target 201c is provided with a microphone-equipped camera 10c for recording the information 301 on a sound and the information 302 on a moving image of the hoisting machine 703 and therearound.

### <Operation of Equipment Recording System Operation for Recording Elevator Equipment Status>

For example, based on the detection result of the weight of the load of the elevator car 701 by the weight sensor 705, in a case where an abnormality (i.e., overload) in the weight of the elevator car 701 of the elevator equipment 700 is recognized by the control device 704, an abnormality-related signal 400 of the elevator equipment 700 is output from the control device 704. Then, the elevator equipment 700 is operated so as to correspond to the abnormality-related signal 400 output from the control device 704, and the microphone-equipped cameras 10a to 10c of the equipment recording system 100 is operated in synchronization with the abnormality-related signal 400 output from the control device 704 of the elevator equipment 700.

That is, from the microphone-equipped camera 10a, the information 301 on the sound of the elevator car 701 and therearound and the information 302 (i.e., the measurement information 300a) on the moving image of the elevator car 701 and therearound, which have been recorded before and after the time point at which the abnormality-related signal 400 of the elevator equipment caused by the detection result of the weight sensor 705 has occurred, are output to the control device 704 of the elevator equipment 700. Similarly, from the microphone-equipped camera 10b (10c), the information 301 on the sound of the wire rope 702 (hoisting machine 703) and therearound and the information 302 (i.e., the measurement information 300a) on the moving image of the wire rope 702 (hoisting machine 703) and therearound, which have been recorded before and after the time point at which the abnormality-related signal 400 of the elevator equipment 700 caused by the detection result of the weight sensor 705 has been recorded, are output to the control device 704 of the elevator equipment 700.

And the processing for associating the measurement information 300a of each of the measurement targets 201a to 201c with the abnormality-related signal 400 of the elevator equipment 700 caused by the detection result of the weight sensor 705 is performed by the control device 704 of the elevator equipment 700. Thereafter, the measurement information 300a on each of the measurement targets 201a to 201c is transmitted from the control device 704 of the elevator equipment 700 to the server 20 of the equipment recording system 100 through the network 500. Then, the measurement information 300a on each of the measurement targets 201a to 201c associated with the abnormality-related signal 400 of the elevator equipment 700 caused by the detection result of the weight sensor 705 is received and stored by the server 20.

From the measurement information 300a stored in the server 20, it is possible to confirm the states of the elevator car 701, the wire rope 702, and the hoisting machine 703 before and after the time point at which the abnormality-related signal 400 of the elevator equipment 700 has occurred. Specifically, it is possible to confirm the state of the elevator car 701, such as, e.g., an abnormal shake and an abnormal sound, from the information 301a on the sound of the elevator car 701 and therearound and the information 302a on the moving image of the sound elevator car 701 and therearound by the microphone-equipped camera 10. Further, from the information 301a on a sound of the wire rope 702 and therearound and the information 302a on the moving image of the wire rope 702 and therearound by the microphone-equipped camera 10b, it is also possible to confirm the state of the wire rope 702, such as, e.g., abnormal looseness. Further, from the information 301a on the sound and the information 302a on the moving image of the hoisting machine 703 and therearound, by the microphone-equipped camera 10c, it is possible to confirm the state of the hoisting machine 703, such as, e.g., the soiling or scratch of the pulley of the hoisting machine 703, the deformation of the wire rope 702 wound on the hoisting machine 703, and the abnormal sound of the pulley of the hoisting machines 703.

In the above, the operation when the abnormality-related signal 400 of the elevator equipment 700 caused by the detection result of the weight sensor 705 is generated has been described. The same operation is performed when the abnormality-related signal 400 of the elevator equipment 700 caused by the detection result of the magnetic sensor 706 has occurred. That is, in a case where the abnormality of the state of the wire rope 702 of the elevator equipment 700 (i.e., scratches of the wire rope 702) is recognized by the control device 704 based on the detection result of the state of the wire rope 702 by the magnetic sensor 706, the abnormality-related signal 400 of the elevator equipment 700 is output from the control device 704. Then, the elevator equipment 700 is operated so as to correspond to the abnormality-related signal 400 output from the control device 704, and the microphone-equipped cameras 10a to 10c of the equipment recording system 100 are operated in synchronization with the abnormality-related signal 400 output from the control device 704 of the elevator equipment 700. Although the detailed description will be omitted, the same operation as that described above will be performed thereafter.

(Effects of this Embodiment)

In this embodiment, the following effects can be obtained.

In this embodiment, as described above, the equipment recording system 100 is provided with the server 20 that receives and stores the information 301a on a sound of the measurement target 201 and the information 302a on the moving image of the measurement target 201 via the network 500. Accordingly, in the server 20 arranged at a remote location away from the equipment 200, it is possible to manage the measurement information 300a on the measurement target 201, which is the information 301a on the sound of the measurement target 201 and the information 302a on the moving image of the measurement target 201. As a result, in a case where the operator of the equipment 200 differs from the operator of the equipment recording system 100, the operator belonging to the operator of equipment recording system 100 can freely manage the server 20. Therefore, it is possible to easily manage the measurement information 300a on the stored measurement target 201.

In this embodiment, as described above, the information 301a on the sound of measurement target 201 and the information 302a on the moving image of the measurement target 201 are stored in a state of being associated with the abnormality-related signal 400 of the equipment 200. As a result, it is possible to assuredly confirm the correspondence between the measurement information 300a on the measurement target 201, which is the stored information 301a on the sound of the measurement target 201 and the stored information 302a on the moving image of the measurement target 201, and the abnormality of the equipment 200. As a result, it is possible to suppress that the correspondence between the stored measurement information 300a of the measurement target 201 and the abnormality of the equipment 200 are not known when measuring the measurement information 300a on the measurement target 201. With this, the stored measurement information 300a on the measurement target 201 can be easily analyzed. As a result, it is possible to provide an equipment recording system 100 capable of easily managing the stored measurement information 300a on the measurement target 201 and easily analyzing the measurement information 300a on the stored measurement target 201.

Further, as in the equipment recording system 100 according to this embodiment, in the configuration in which the server 20 is arranged at a remote location away from the equipment 200 to store the measurement information 300a on the measurement target 201, the server 20 is positioned at a remote location away from the equipment 200. For this reason, it is not easy to confirm the correspondence between the measurement information 300a on the measurement target 201 and abnormality-related signal 400 of the equipment 200 ex post facto. Therefore, as described above, in this configuration in which the measurement information 300a on the measurement target 201 is stored in the server 20 placed at the remote location away from the equipment 200, it is particularly useful that the measurement information 300a on the measurement target 201 can be easily analyzed by suppressing that the correspondence with the abnormality of the equipment 200 is not known.

Further, in this embodiment, as described above, the microphone and the camera of the equipment recording system 100 are configured by the microphone-equipped camera 10 capable of recording both the information 301a on a sound of the measurement target 201 and the information 302a on the moving image of measurement target 201. With this, both the information 301a on the sound of the measurement target 201 and the information 302a on the moving image of the measurement target 201 can be simultaneously recorded by the microphone-equipped camera 10. Therefore, when the abnormality-related signal 400 of the equipment 200 has occurred, it is possible to store both the information 301a on the sound of the management target 201 and the information 302a on the moving image of the measurement target 201, which are recorded before and after the time point at which the abnormality-related signal 400 of the measurement target 201 has occurred, in the server 20 in a state of being associated with the abnormality-related signal 400 of the equipment 200. As a result, when analyzing the measurement information 300a on the measurement target 201, both the information 301a on the sound of the measurement target 201 and the information 302a on the moving image of the measurement target 201, which have been recorded before and after the time point at which the abnormality-related signal 400 of the equipment 200 has occurred, can be confirmed together with the correspondences with the abnormalities of equipment 200. This makes it easier to analyze the information.

In this embodiment, as described above, the equipment 200 is configured to include a plurality of measurement targets 201 different from each other. Further, a microphone-equipped camera 10 is provided to each of the plurality of measurement targets 201. As a result, the information 301a on the sound and the information 302a on the moving image of each of the plurality of measurement targets 201 different from each other can be recorded. For this reason, more pieces of the information 301a on the sound and more pieces of the information 302a on the moving image of the measurement target 201 can be obtained as compared with the case in which the information 301a on a sound and the information 302a on the moving image of only a single measurement target 201 are recorded. This makes it easier to analyze the information.

Further, in this embodiment, as described above, when the abnormality-related signal 400 of the equipment 200 has occurred, the equipment recording system 100 is configured such that the information 301a on the sound and the information 302a on the moving image of the measurement target 201 by all of the microphone-equipped cameras 10 are stored in the server 20 in a state of being associated with the abnormality-related signal 400 of the equipment 200.

With this, unlike the case in which the information 301a on the sound and the information 302a on the moving image of only some of the measurement targets 201 are stored in the server 20, it is possible to confirm the information 301a on the sound and the information 302a on the moving image of all of the measurement targets 201 at the time of analyzing the measurement information 300a of the measurement target 201. As a result, even in the measurement target 201 which is seemed to be unrelated to the abnormality-related signal 400 of the equipment 200, the information 301a on the sound and the information 302a on the moving image are also stored. Therefore, since the information quantity of the measurement target 201 at the time of analyzing the measurement information 300a can be increased, it is possible to easily obtain a significant analysis result.

In this embodiment, as described above, the equipment recording system 100 is configured such that the information 301a on the sound and the information 302a on the moving image of each of the plurality of measurement targets 201 are grouped for each of the generated abnormality-related signals 400 of the equipment 200.

As a result, at the time of analyzing the measurement information 300a of the measurement target 201, it is possible to utilize the information 301a on the sound and the information 302a on the moving image of each of the plurality of measurement targets 201 for each of the groups of the generated abnormality-related signals 400 of the equipment 200. Therefore, the analysis of the measurement information 300a of the measurement target 201 can be performed more easily. This effect is particularly useful in that when abnormality-related signals 400 of the equipment 200 have occurred more than once, the information can be easily and individually used for each group of the generated abnormality-related signals 400 of the equipment 200.

In this embodiment, as described above, the equipment recording system 100 is configured such that the information 301a on the sound and the information 302a on the moving image of each of the plurality of measurement targets 201 are grouped in a unit of a predetermined time range are stored in the server 20.

With this, provided that the significant time range is predetermined as a unit of the time range, when analyzing the measurement information 300a of the measurement target 201, it is possible to utilize the information 301a on the sound and the information 302a on the moving image of each of the plurality of measurement targets 201 for a group in a unit of the significant time range. Therefore, the analysis of the measurement information 300a on the measurement target 201 can be performed more easily. Note that the significant time range differs depending on the equipment 200, but may be, for example, within or outside the business hours of the equipment 200, during the daytime, during the nighttime, and the like.

In this embodiment, as described above, the server 20 is configured such that the stored information 301a on the sound of the measurement target 201 and the stored information 302a on the moving image of the measurement target 201 can be delivered to the user terminal 600 via the network 500.

With this, when the user needs to confirm the information 301a on the sound of measurement target 201 and the information 302a on the moving image of the measurement target 201, the user can confirm the information 301a on the sound of the measurement target 201 and the information 302a on the moving image of the measurement target 201, which need to be confirmed, by the user's own terminal 600.

### Modified Embodiments

It should be understood that the embodiments disclosed here are examples in all respects and are not restrictive. The scope of the present invention is shown by the scope of claims rather than the descriptions of the embodiments described above, and includes all changes (modifications) within the meaning of equivalent and the scope of claims.

For example, in the above-described embodiment, an example is shown in which the microphone and the camera of the equipment recording system each are a microphone-equipped camera, but the present invention is not limited thereto. In the present invention, in a case where it is not required to record the information on the moving image of the measurement target of the equipment, the microphone of the equipment recording system may be just a microphone, not a microphone-equipped camera. Similarly, in a case where the information on the sound of the measurement target of the equipment is not required to be recorded, the camera of the equipment recording system may be just a camera, not a microphone-equipped camera. In addition, the equipment recording system may include only one of a microphone and a camera as the recording part for the information on the measurement target.

Further, in the above-described embodiment, an example is shown in which when an abnormality-related signal of the facility has occurred, the information on the sound and the information on the moving image of the measurement target by all of the microphone-equipped cameras are output from microphone-equipped cameras and stored in the server. But the present invention is not limited to this. In the present invention, when an abnormality-related signal of the equipment has occurred, the information on the sound and the information on the moving image of the measurement target by some microphone-equipped cameras may be output from the microphone-equipped cameras and stored in the server. In this case, from some microphone-equipped cameras predetermined in response to a generated abnormality-related signal of the equipment, the information on a sound and the information on the moving image of the measurement target may be outputted.

In the above-described embodiment, an example is shown in which the information on a sound and the information on a moving image of the plurality of measurement targets are stored in the server so as to be grouped for each generated abnormality-related signal of the equipment, but the present invention is not limited to this. In the present invention, the information on a sound and the information on a moving image of a plurality of measurement targets may be stored in the server so as to be grouped in a unit of the type of the occurred abnormality-related signal. Further, in the present invention, the information on a sound and the information on a moving image of a plurality of measurement targets may be stored in the server so as to be grouped for each measurement target (for each microphone-equipped camera). With this configuration, the information on a sound and the information on a moving image of a particular measurement target can be observed at a fixed point. Therefore, it is possible to easily confirm whether or not there are differences in the content (behavior) of the information on a sound and the information on a moving image of a particular measurement target by the abnormality-related signal of the equipment or the period of time.

1. An equipment recording system comprising:
at least one of a microphone and a camera;
a sensor; and
a server,
wherein the microphone is configured to record information on a sound of a measurement target of equipment,
wherein the camera is configured to record information on a moving image of the measurement target,
wherein the sensor is configured to detect additional information including at least a magnetism,
wherein the sensor includes a magnetic sensor that magnetically detects the state of a wire rope, and
wherein the server is configured to:
receive at least one of the information on the sound of the measurement target and the information on the moving image of the measurement target via a network, the information on the sound and the information on the moving image having been recorded before and after a time when an abnormality-related signal of the equipment occurred; and
store at least one of received information on the sound of the measurement target and received information on the moving image of the measurement target and the additional information in a state of being associated with the abnormality-related signal of the equipment,
wherein the abnormality-related signal of the equipment is caused by the detection result of the sensor including at least the magnetism, and
wherein the equipment includes the wire rope for transporting people and luggage.

2. The equipment recording system as recited in claim 1,
wherein the microphone and the camera each are a microphone-equipped camera capable of recording both the information on the sound of the measurement target and the information on the moving image of the measurement target.

3. The equipment recording system as recited in claim 2,
wherein the equipment includes a plurality of measurement targets different from each other, and
wherein the microphone-equipped camera is provided at each of the plurality of measurement targets.

4. The equipment recording system as recited in claim 3,
wherein it is configured such that, when the abnormality-related signal of the equipment has occurred, the information on the sound of the measurement target and the information on the moving image of the measurement target by all of the microphone-equipped cameras are stored in the server in a state of being associated with the abnormality-related signal of the equipment.

5. The equipment recording system as recited in claim 3,
wherein it is configured such that the information on each sound of the plurality of measurement targets and the information on each moving image of the plurality of measurement targets are stored in the server so as to be grouped for each of occurred abnormality-related signals of the equipment.

6. The equipment recording system as recited in claim 3,
wherein it is configured such that the information on the sound of each of the plurality of measurement targets and the information on the moving image of each of the plurality of measurement targets are stored in the server so as to be grouped in a unit of a predetermined time range.

7. The equipment recording system as recited in claim 1,
wherein the server is configured to be capable of delivering at least one of the information on the sound of the measurement target and the information on the moving image of the measurement target to a user terminal via the network.

8. A equipment recording method comprising the steps of:
recording at least one of information on a sound of a measurement target of equipment and information on a moving image of the measurement target;
receive via a network at least one of the information on the sound of the measurement target and the information on the moving image of the measurement target recorded before and after a time when an abnormality-related signal of equipment occurred; and
storing at least one of the received information on the sound of the measurement target and the received information on the moving image of the measurement target and additional information in a state of being associated with the abnormality-related signal of the equipment,
wherein the abnormality-related signal of the equipment is caused by the detection result of a sensor including at least a magnetism, and
wherein the sensor includes a magnetic sensor that magnetically detects the state of a wire rope,
wherein the additional information includes at least the magnetism detected by the sensor, and
wherein the equipment includes the wire rope for transporting people and luggage.
